(19) United States
(12) Patent Application Publication
(10) Pub. No.: US 2025/0317973 A1
(43) Pub. Date: Oct. 9, 2025

(54) PHYSICAL RANDOM ACCESS CHANNEL CONFIGURATIONS FOR SPATIAL DOMAIN ADAPTATION

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Muhammad Sayed Khairy ABDELGHAFFAR, San Jose, CA (US); Peter GAAL, San Diego, CA (US)

(21) Appl. No.: 18/626,907

(22) Filed: Apr. 4, 2024

(51) Int. Cl. H04W 74/0833; H04W 48/08

(52) U.S. Cl. CPC H04W 74/0833; H04W 48/08

(57) ABSTRACT

Various aspects of the present disclosure generally relate to wireless communication. In some aspects, a user equipment (UE) may receive configuration information indicating a plurality of physical random access channel (PRACH) configurations, wherein each PRACH configuration, of the plurality of PRACH configurations, indicates a respective subset of synchronization signal blocks (SSBs), from a set of SSBs, that are mapped to random access channel (RACH) occasions (ROs) associated with that PRACH configuration. The UE may transmit a PRACH transmission in an RO associated with a PRACH configuration of the plurality of PRACH configurations in accordance with the configuration information. Numerous other aspects are described.

### FIELD OF THE DISCLOSURE

Aspects of the present disclosure generally relate to wireless communication and specifically relate to techniques, apparatuses, and methods for physical random access channel configurations for spatial domain adaptation.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be individually or collectively configured to receive configuration information indicating a plurality of physical random access channel (PRACH) configurations, wherein each PRACH configuration, of the plurality of PRACH configurations, indicates a respective subset of synchronization signal blocks (SSBs), from a set of SSBs, that are mapped to random access channel (RACH) occasions (ROs) associated with that PRACH configuration. The one or more processors may be individually or collectively configured to transmit a PRACH transmission in an RO associated with a PRACH configuration of the plurality of PRACH configurations in accordance with the configuration information.

Some aspects described herein relate to a network node for wireless communication. The network node may include one or more memories and one or more processors coupled to the one or more memories. The one or more processors may be individually or collectively configured to transmit configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The one or more processors may be individually or collectively configured to receive, from a UE, a PRACH transmission in an RO associated with a PRACH configuration of the plurality of PRACH configurations in accordance with the configuration information.

Some aspects described herein relate to a method of wireless communication performed by a UE. The method may include receiving configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The method may include transmitting a PRACH transmission in an RO associated with a PRACH configuration of the plurality of PRACH configurations in accordance with the configuration information.

Some aspects described herein relate to a method of wireless communication performed by a network node. The method may include transmitting configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The method may include receiving, from a UE, a PRACH transmission in an RO associated with a PRACH configuration of the plurality of PRACH configurations in accordance with the configuration information.

Some aspects described herein relate to a non-transitory computer-readable medium that stores a set of instructions for wireless communication by a UE. The set of instructions, when executed by one or more processors of the UE, may cause the UE to receive configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The set of instructions, when executed by one or more processors of the UE, may cause the UE to transmit a PRACH transmission in an RO associated with a PRACH configuration of the plurality of PRACH configurations in accordance with the configuration information.

Some aspects described herein relate to a non-transitory computer-readable medium that stores a set of instructions for wireless communication by a network node. The set of instructions, when executed by one or more processors of the network node, may cause the network node to transmit configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The set of instructions, when executed by one or more processors of the network node, may cause the network node to receive, from a UE, a PRACH transmission in an RO associated with a PRACH configuration of the plurality of PRACH configurations in accordance with the configuration information.

Some aspects described herein relate to an apparatus for wireless communication. The apparatus may include means for receiving configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The apparatus may include means for transmitting a PRACH transmission in an RO associated with a PRACH configuration of the plurality of PRACH configurations in accordance with the configuration information.

Some aspects described herein relate to an apparatus for wireless communication. The apparatus may include means for transmitting configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The apparatus may include means for receiving, from a UE, a PRACH transmission in an RO associated with a PRACH configuration of the plurality of PRACH configurations in accordance with the configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network.

FIG. 3 is a diagram illustrating an example disaggregated base station architecture in accordance with the present disclosure.

FIG. 4 is a diagram illustrating an example of a four-step random access procedure, in accordance with the present disclosure.

FIGS. 5A-5C are diagrams illustrating an example associated with physical random access channel (PRACH) configurations for spatial domain adaptation, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIGS. 8-9 are diagrams of an example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless communication network, a user equipment (UE) and a network node may perform a random access procedure to establish a radio resource control (RRC) connection between the UE and the network node. The UE may initiate the random access procedure by transmitting a physical random access channel (PRACH) transmission including a PRACH preamble to the network node. In some examples, the network node may broadcast different synchronization signal blocks (SSBs) (also referred to as synchronization signal (SS)/physical broadcast channel (PBCH) blocks) using different beams. The SSBs may be associated with respective SSB indexes (or SS/PBCH block indexes). The UE may detect one or more SSBs broadcast by the network node and measure a signal strength of each detected SSB. In some examples, the UE may select a strongest SSB and transmit the PRACH transmission using the beam associated with the selected SSB. In such examples, the UE may transmit the PRACH transmission in a random access channel (RACH) occasion (RO) associated with the selected SSB. For example, the network node may transmit (e.g., in a system information block (SIB) type 1 (SIB1)), and the UE may receive, a random access configuration that indicates parameters that define a mapping between SSBs and ROs (e.g., time and frequency resources available for transmitting a PRACH transmission). The UE may determine the RO associated with the selected SSB based in the mapping between the SSBs and the ROs. The network node may determine the selected SSB (and the corresponding beam) based on the RO in which the PRACH transmission is received.

Spatial domain adaptation of the PRACH can provide network energy savings by exploiting an uneven distribution of PRACH resources across different beam directions. For example, spatial domain adaptation may result in a larger number of ROs for certain beam directions (e.g., for certain SSBs) and a smaller number of ROs for other beam directions (e.g., for other SSBs). In addition to providing network energy savings, spatial domain adaptation of PRACH resources may be beneficial for full-duplex operation to minimize cross-link interference (CLI) (e.g., resulting from PRACH transmission) in certain beam directions over other beam directions. In some examples, a network may adapt a number of ROs in the time domain by adding ROs to a baseline configuration or removing ROs from the baseline configuration. However, such adaptation in the time domain cannot be selectively performed for certain beam directions, and thus does not enable the network to perform spatial domain adaptation of the PRACH resources. Furthermore, by simply adding ROs to the baseline configuration or removing some ROs from the baseline configuration, the network may maintain minimal control of the RACH process (e.g., the random access procedure). For example, even when ROs are added to or removed from the baseline configuration, the same baseline configuration, including all power control parameters of the baseline configuration, is used by the UE for PRACH transmissions and re-transmissions in all of the ROs.

Various aspects relate generally to spatial domain adaptation of PRACH resources. Some aspects more specifically relate to PRACH configurations for spatial domain adaptation. In some aspects, a UE may receive configuration information indicating a plurality of PRACH configurations. Each PRACH configuration, of the plurality of PRACH configurations, may indicate a respective subset of SSBs, from a set of SSBs, that are mapped to ROs associated with that PRACH configuration. The UE may transmit a PRACH transmission in an RO associated with a PRACH configuration of the plurality of PRACH configurations in accordance with the configuration information.

Particular aspects of the subject matter described in this disclosure can be implemented to realize one or more of the following potential advantages. In some examples, by indicating, in the configuration information received by the UE, multiple PRACH configurations, each indicating a respective subset of SSBs that are mapped to the ROs associated with that PRACH configuration, the described techniques can be used to enable spatial domain adaptation of PRACH resources in a wireless communication network, which may result in network energy savings.

In some aspects, different SSBs may be associated with different PRACH configurations and/or different quantities of PRACH configurations. In such examples, by associating different SSBs with different PRACH configurations and/or different quantities of PRACH configurations, the network can better manage spatial domain adaptation, including configuring different optimization parameters relating to power control, retransmission, and/or PRACH preamble usage, among other examples, for the different PRACH configurations. In some aspects, the network may enable and/or disable certain PRACH configurations, of the plurality of PRACH configurations. In such examples, by enabling and/or disabling certain PRACH configurations, the network may enable and/or disable PRACH configurations with ROs that are associated with certain beam directions (e.g., certain SSBs). As a result, the network may be enabled to perform adaptation in the time domain that is selective with respect to certain beam directions. Such time domain and spatial domain adaptation of PRACH resources may result in increased network energy savings.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

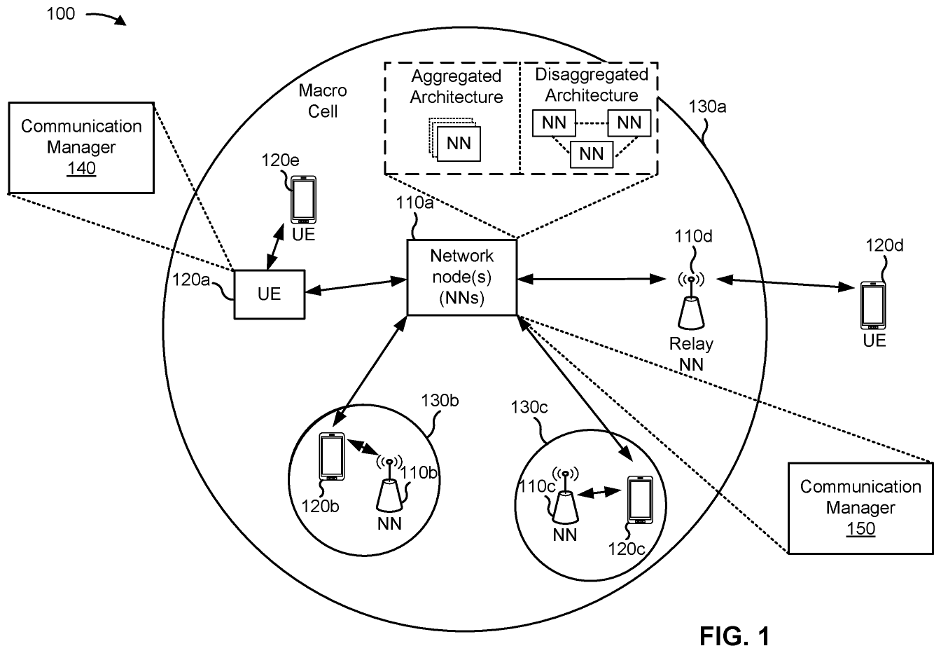

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive configuration information indicating a plurality of PRACH configurations, wherein each PRACH configuration, of the plurality of PRACH configurations, indicates a respective subset of SSBs, from a set of SSBs, that are mapped to ROs associated with that PRACH configuration; and transmit a PRACH transmission in an RO associated with a PRACH configuration of the plurality of PRACH configurations in accordance with the configuration information. Additionally, or alternatively, the communication manager 140 may perform one or more other operations described herein.

In some aspects, the network node 110 may include a communication manager 150. As described in more detail elsewhere herein, the communication manager 150 may transmit configuration information indicating a plurality of PRACH configurations, wherein each PRACH configuration, of the plurality of PRACH configurations, indicates a respective subset of SSBs, from a set of SSBs, that are mapped to ROs associated with that PRACH configuration; and receive, from a UE, a PRACH transmission in an RO associated with a PRACH configuration of the plurality of PRACH configurations in accordance with the configuration information. Additionally, or alternatively, the communication manager 150 may perform one or more other operations described herein.

As indicated above, FIG. 1 is provided as an example. Other examples may differ from what is described with regard to FIG. 1.

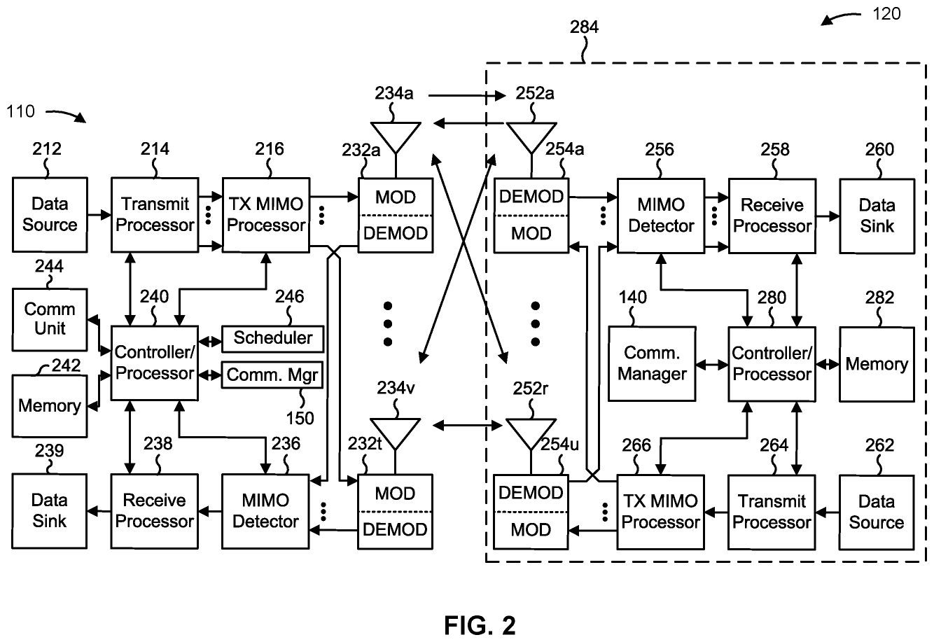

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

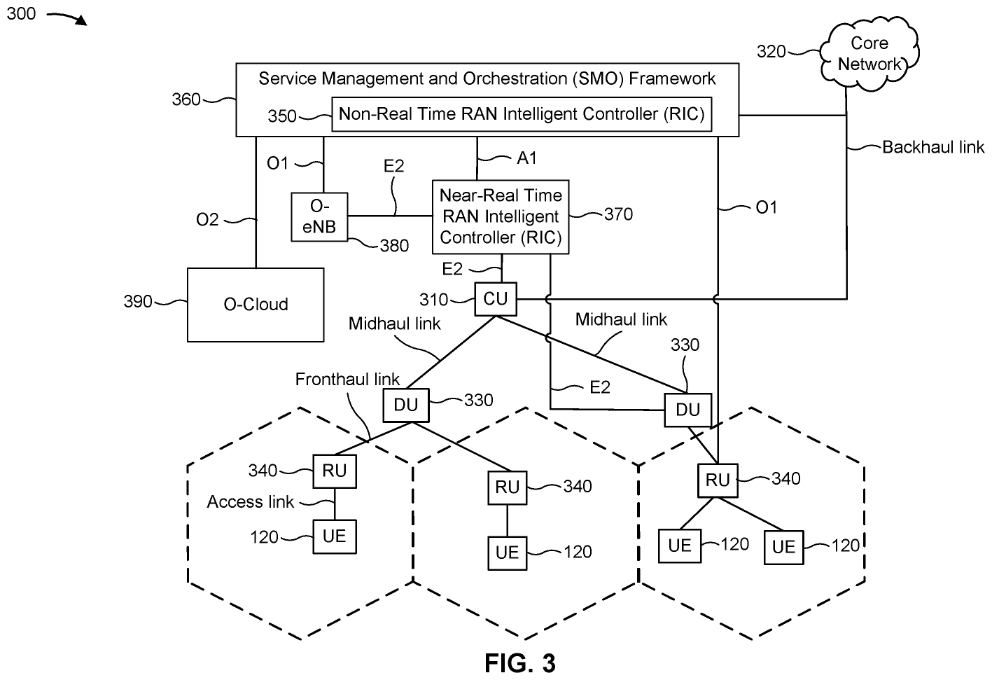

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

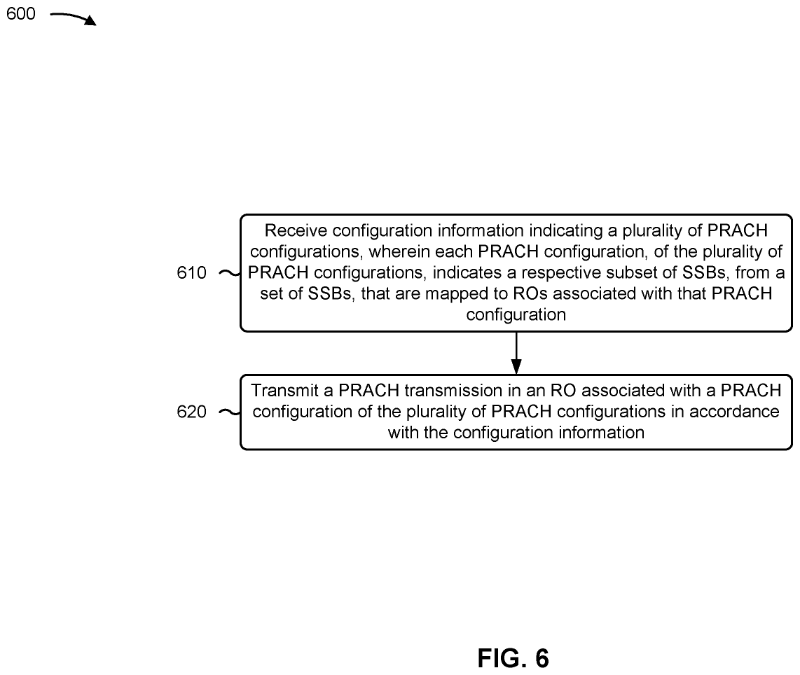

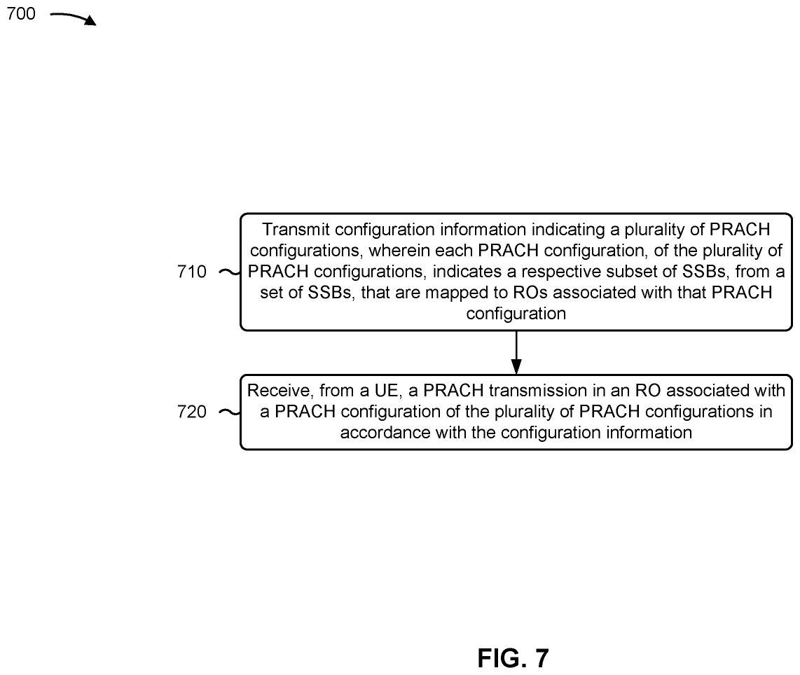

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with PRACH configurations for spatial domain adaptation, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 600 of FIG. 6, process 700 of FIG. 7, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

In some aspects, the UE 120 includes means for receiving configuration information indicating a plurality of PRACH configurations, wherein each PRACH configuration, of the plurality of PRACH configurations, indicates a respective subset of SSBs, from a set of SSBs, that are mapped to ROs associated with that PRACH configuration; and/or means for transmitting a PRACH transmission in an RO associated with a PRACH configuration of the plurality of PRACH configurations in accordance with the configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information indicating a plurality of PRACH configurations, wherein each PRACH configuration, of the plurality of PRACH configurations, indicates a respective subset of SSBs, from a set of SSBs, that are mapped to ROs associated with that PRACH configuration; and/or means for receiving, from a UE, a PRACH transmission in an RO associated with a PRACH configuration of the plurality of PRACH configurations in accordance with the configuration information. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

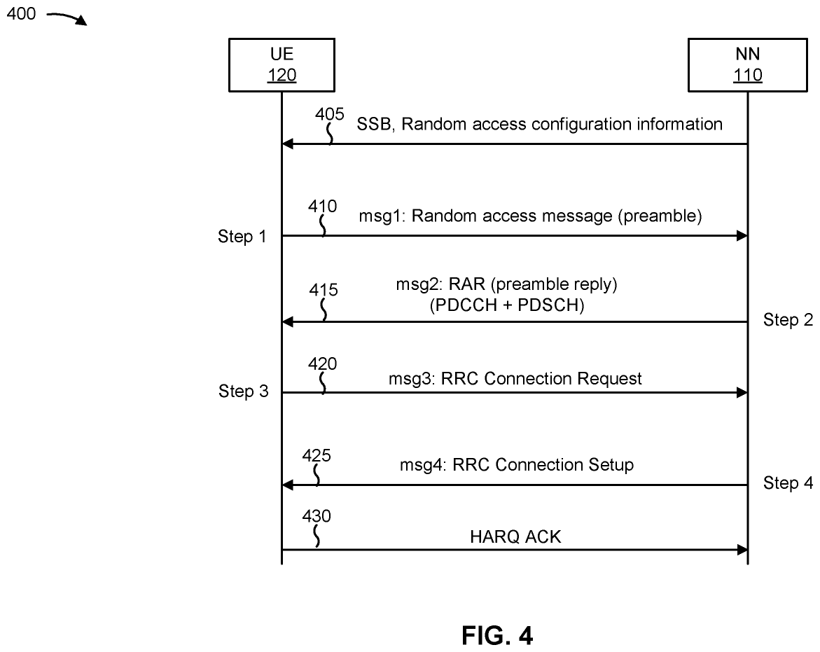

FIG. 4 is a diagram illustrating an example 400 of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some examples, the network node 110 may transmit multiple SSBs in different beam directions, and the UE 120 may detect (e.g., receive) one or more of the SSBs transmitted by the network node 110. The UE may measure the signal strength of each detected SSB and select an SSB (e.g., an SSB detected with the strongest signal strength). In some examples, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving random access response (RAR). For example, the random access configuration may include parameters for mapping SSBs indexes to ROs for transmitting the RAM.

As shown by reference number 410, the UE 120 may transmit a RAM, which may include a preamble (sometimes referred to as a random access preamble, a PRACH preamble, a RACH preamble, or a RAM preamble). The message that includes the preamble may be referred to as a PRACH transmission, a message 1, msg1, msg-1, MSG1, a first message, or an initial message in a four-step random access procedure. The RAM may include a random access preamble identifier. In some examples, the UE 120 may transmit the RAM in an RO associated with the SSB index of the SSB selected by the UE 120 based at least in part on the parameters, included in the ransom access configuration, for mapping the SSBs indexes to ROs. In this way, the network node 110 may identify the SSB (e.g., and the corresponding beam direction) selected by the UE 120.

As shown by reference number 415, the network node 110 may transmit an RAR as a reply to the preamble. The message that includes the RAR may be referred to as message 2, msg2, msg-2, MSG2, or a second message in a four-step random access procedure. In some examples, the RAR may indicate the detected random access preamble identifier (e.g., received from the UE 120 in msg1). Additionally, or alternatively, the RAR may indicate a resource allocation to be used by the UE 120 to transmit message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, msg-3, MSG3, or a third message of a four-step random access procedure. In some examples, the RRC connection request may include a hybrid automatic repeat request (HARQ) identifier, UCI, and/or a HARQ communication (e.g., an RRC connection request).

As shown by reference number 425, the network node 110 may transmit an RRC connection setup message. The RRC connection setup message may be referred to as message 4, msg4, msg-4, MSG4, or a fourth message of a four-step random access procedure. In some examples, the RRC connection setup message may include the detected HARQ identifier, a timing advance value, and/or contention resolution information. As shown by reference number 430, if the UE 120 successfully receives the RRC connection setup message, the UE 120 may transmit a HARQ acknowledgement (ACK).

As indicated above, FIG. 4 is provided as an example. Other examples may differ from what is described with regard to FIG. 4.

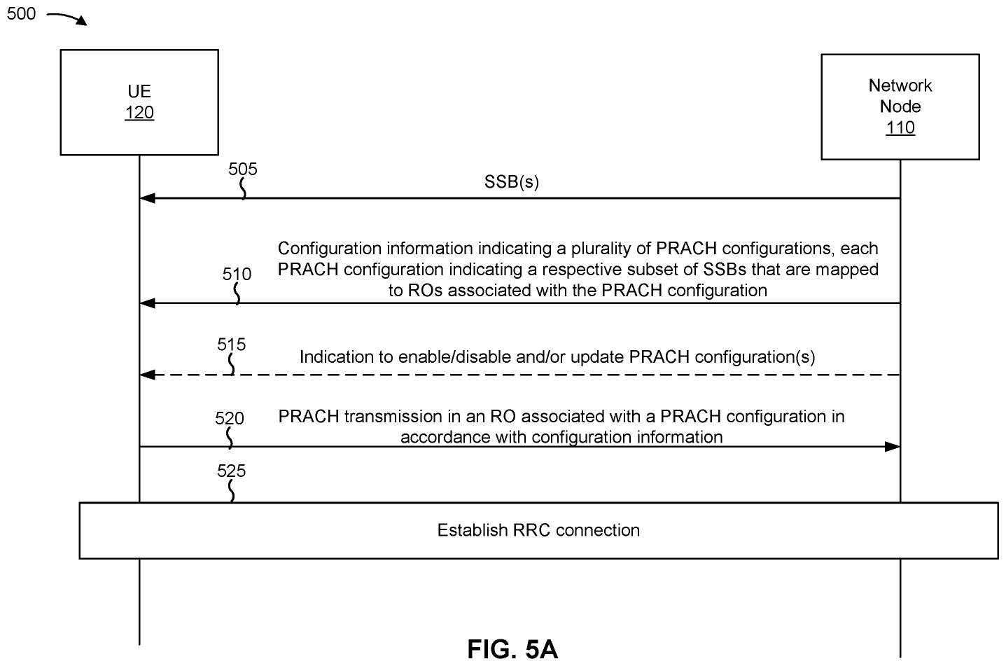

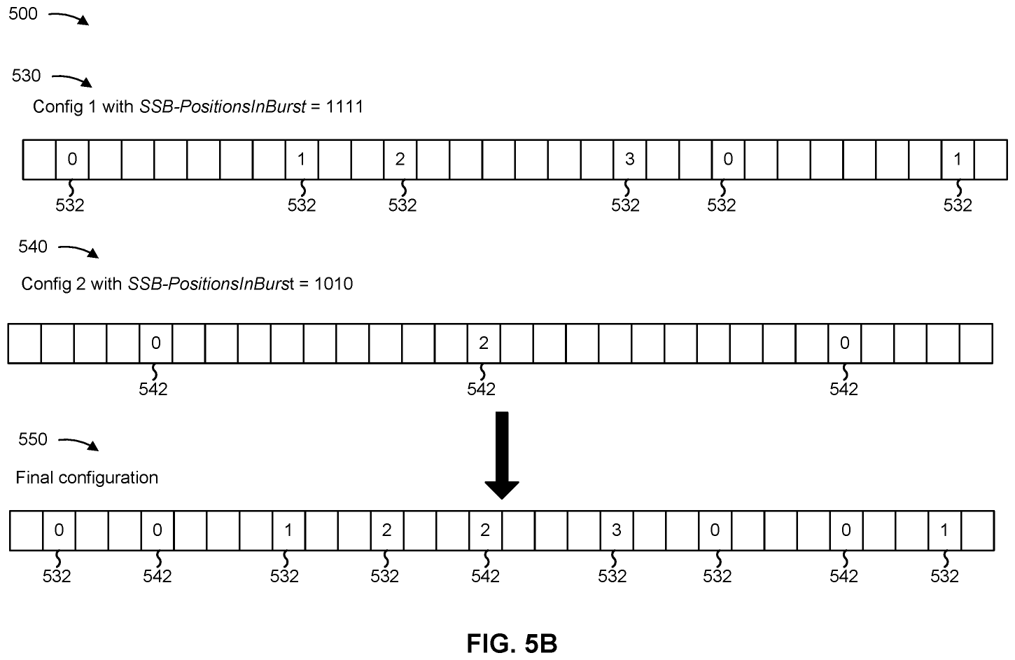

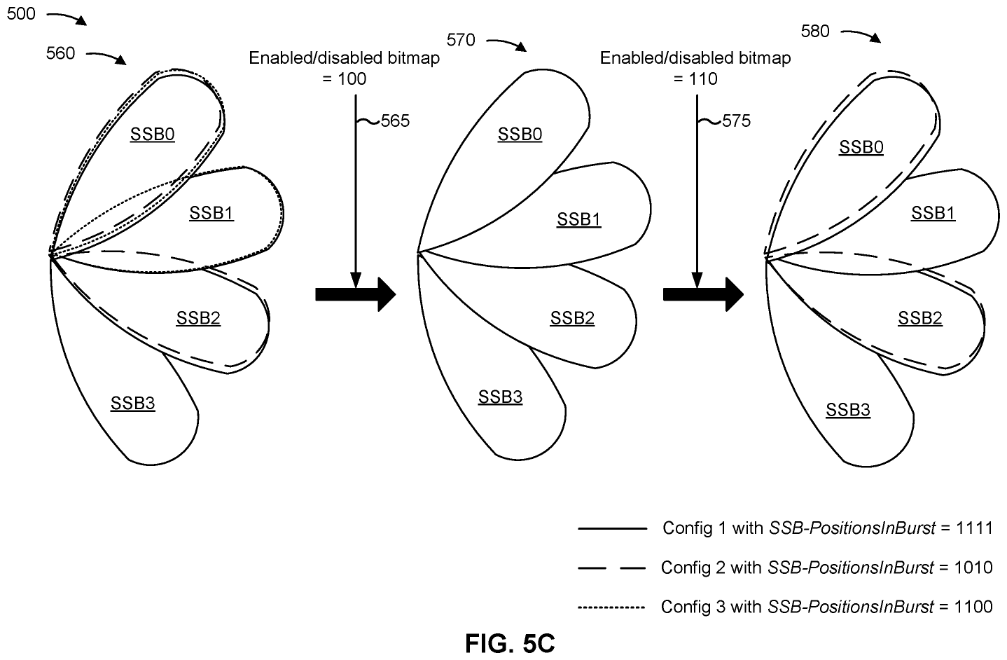

FIGS. 5A-5C are diagrams illustrating an example 500 associated with PRACH configurations for spatial domain adaptation, in accordance with the present disclosure. As shown in FIG. 5A, example 500 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

As shown in FIG. 5A, and by reference number 505, the network node 110 may transmit, and the UE 120 may receive, one or more SSBs. In some aspects, the network node 110 may transmit (e.g., broadcast) multiple SSBs using different beams. The SSBs may be associated with respective SSB indexes. In some aspects, the network node 110 may transmit a plurality of SSBs in an SSB burst. The UE 120 may detect (e.g., receive) one or more of the SSBs transmitted by the network node 110. The UE 120 may measure a signal strength of each detected SSB, and the UE 120 may select an SSB based at least in part on the signal strength measurements of the one or more detected SSBs. For example, the UE 120 may select a strongest SSB (e.g., an SSB with the strongest signal strength) of the one or more detected SSBs.

As further shown in FIG. 5A, and by reference number 510, the network node 110 may transmit, and the UE 120 may receive, configuration information. That configuration information may indicate a plurality of PRACH configurations, and each PRACH configuration, of the plurality of PRACH configurations, may indicate a respective subset of SSBs, from a set of SSBs, that are mapped to ROs associated with that PRACH configuration. In some examples, the PRACH configurations that indicate the respective subset of SSBs may also be referred to as “RACH configurations.” In some aspects, the configuration information indicating the multiple PRACH configurations may be included in a SIB (e.g., SIBx). For example, the configuration information indicating the multiple PRACH configurations may be indicated in a SIB (e.g., SIBx) that is broadcast by the network node 110 and received by the UE 120 (e.g., when the UE 120 is operating in an RRC idle or inactive state). In some examples, the configuration information indicating the multiple PRACH configurations may be included in SIB1. Additionally, or alternatively, the configuration information indicating the multiple PRACH configurations may be included in one or more other SIBs and/or one or more other RRC messages, such as in a dedicated or common RRC configuration (e.g., when the UE 120 is operating in an RRC connected state).

Each PRACH configuration, of the plurality of PRACH configurations indicated in the configuration information, may include an indication of the respective subset of SSBs, from the set of SSBs, that are mapped to the ROs associated with that PRACH configuration. In some aspects, the indication may be a bitmap that indicates which SSBs, from the set of SSBs, are included in the respective subset of SSBs for the PRACH configuration. That is, each PRACH configuration, of the plurality of PRACH configurations, may include a respective bitmap that indicates which SSBs, of the set of SSBs, are included in the respective subset of SSBs that are mapped to the ROs associated with that PRACH configuration. In some examples, the set of SSBs may be the SSBs included in an SSB burst. The number of bits included in the bitmap associated with a PRACH configuration may be the same as the number of SSBs in the set of SSBs (e.g., the number of SSBs in the SSB burst), with each bit in the bitmap indicating whether a respective SSB, of the set of SSBs, is included in the respective subset of SSBs that are mapped to the ROs associated with that PRACH configuration. For example, each bit map may have a first value (e.g., 1) indicating that the corresponding RO, from the set of ROs, is mapped to the ROs associated with the PRACH configuration, or a second value (e.g., 0) indicating that the corresponding RO, from the set of ROs, is not mapped to the ROs associated with the PRACH configuration.

In some aspects, each PRACH configuration, of the plurality of PRACH configurations, may include a respective information element (IE) for indicating the respective subset of SSBs that are mapped to the ROs associated with that PRACH configuration. For example, the information element for indicating the respective subset of SSBs for a PRACH configuration may be an SSB-PositionInBurst IE. In such examples, each PRACH configuration, of the plurality of PRACH configurations, may include a respective SSB-PositionInBurst IE. In some aspects, the respective IE (e.g., the SSB-PositionInBurst IE) included in each PRACH configuration, of the plurality of PRACH configurations, may include the respective bitmap that indicates which SSBs, of the set of SSBs, are included in the respective subset of SSBs that are mapped to the ROs associated with the PRACH configuration.

In some aspects, the configuration information may indicate all RACH/PRACH parameters for the plurality of PRACH configurations via separate IEs. For example, the configuration information may include a respective RACH-ConfigCommon IE for each PRACH configuration. That is, in a case in which the configuration information indicates a first PRACH configuration and a second PRACH configuration, the configuration information may include a first RACH-ConfigCommon IE associated with the first PRACH configuration and a second RACH-ConfigCommon IE associated with the second PRACH configuration. In such examples, the IE (e.g., SSB-PositionInBurst) for indicating the respective subset of SSBs associated with a PRACH configuration may be included in the respective SSB-PositionInBurst IE associated with the PRACH configuration. In some other aspects, the configuration information may indicate some RACH/PRACH parameters that are shared by the plurality of PRACH configurations in a common IE, and the configuration information may indicate other PRACH/PRACH parameters for the plurality of PRACH configurations in other respective separate IEs. For example, the configuration information may include respective RACH-ConfigGeneric IEs associated with the plurality of PRACH configurations under a RACH-ConfigCommon IE that indicates PRACH/RACH parameters common to the plurality of PRACH configurations. That is, in a case in which the configuration information indicates a first PRACH configuration and a second PRACH configuration, the configuration information may include a first RACH-ConfigGeneric IE associated with the first PRACH configuration and a second RACH-ConfigGeneric IE associated with the second PRACH configuration under a RACH-ConfigCommon IE. In such examples, the IE (e.g., SSB-PositionInBurst) for indicating the respective subset of SSBs associated with a PRACH configuration may be included in the respective SSB-PositionInBurst IE associated with the PRACH configuration.

In some aspects, the SSB-to-RO mapping may be configured independently across the ROs associated with each PRACH configuration. In some examples, each PRACH configuration, of the plurality of PRACH configurations, may indicate a respective SSB-to-RO mapping that maps the respective subset of SSBs (e.g., indicated by the respective bitmap) to the ROs associated with that PRACH configuration. Because each PRACH configuration separately indicates the respective subset of SSBs that is mapped to the ROs associated with that PRACH configuration, some of the SSBs that are mapped to ROs associated with one PRACH configuration may not be mapped to ROs associated with another PRACH configuration. In some aspects, one or more other parameters relating to PRACH transmission, such as parameters relating to power control, retransmission, and/or PRACH preamble usage, among other examples, may be separately configured (e.g., separately indicated in the configuration information) for the plurality of PRACH configurations. For example, the network node 110 (or another network device) may determine the selection of the subsets of SSBs, the SSB-to-RO mappings, and/or the other parameters for the plurality of PRACH configurations to optimize network power savings.

FIG. 5B shows an example of a first PRACH configuration and a second PRACH configuration that map respective subsets of SSBs, from a set of SSBs, to respective ROs. In the example shown in FIG. 5B, the set of SSBs includes four SSBs (e.g., SSB0, SSB1, SSB2, and SSB3), and the first and second PRACH configurations may include respective indications of which SSBs, from the set of four SSBs (e.g., SSB0, SSB1, SSB2, and SSB3), are included in the respective subsets of SSBs. For example, the set of four SSBs (e.g., SSB0, SSB1, SSB2, and SSB3) may be four SSBs included in an SSB burst. As shown in FIG. 5B, and by reference number 530, the first PRACH configuration (shown as “Config 1”) may indicate a bitmap (e.g., in an SSB-PositionInBurst IE) of 1111 to indicate that SSB0, SSB1, SSB2, and SSB3 are mapped to ROs 532 associated with the first PRACH configuration. As shown by reference number 540, the second PRACH configuration (shown as “Config 2”) may indicate a bitmap (e.g., in an SSB-PositionInBurst IE) of 1010 to indicate that SSB0 and SSB2 are mapped to ROs 542 associated with the second PRACH configuration (e.g., SSB1 and SSB3 are not mapped to the ROs 542 associated with the second PRACH configuration). As shown by reference number 550, the first PRACH configuration and the second PRACH configuration result in a final configuration (e.g., a combined configuration) of the ROs 532 associated with the first PRACH configuration and the ROs 542 associated with the second PRACH configuration. In the final configuration shown in FIG. 5B, SSB0 and SSB2 are mapped to the ROs 532 associated with the first PRACH configuration and the ROs 542 associated with the second PRACH configuration, and SSB1 and SSB3 are mapped only to the ROs 532 associated with the first PRACH configuration, thus providing spatial domain adaptation of the PRACH resources. In this example, the UE 120 may select an RO in which to transmit a PRACH transmission from the ROs 532 and 542 associated with the first and second PRACH resources, depending on an SSB selected by the UE 120.

In some cases, the ROs associated with different PRACH configurations of the plurality of RACH configurations may overlap. For example, at least one RO associated with a first PRACH configuration may overlap with at least one RO associated with a second PRACH configuration in the time domain. Two ROs overlap in the time domain when the two ROs are scheduled using at least one concurrent time domain resource (e.g., OFDM symbol). Each PRACH configuration, of the plurality of PRACH configurations, may be associated with a respective index. In some aspects, in a case in which multiple ROs associated with different PRACH configurations overlap, a frequency offset may be associated with (e.g., added to) one or more of the overlapping ROs based at least in part on the values of the indexes associated with the PRACH configurations for the overlapping ROs. In some examples, starting with a baseline PRACH configuration with a lowest index value, the frequency offset can be added to each following PRACH configuration (with an overlapping RO) associated with a higher index value. For example, if a first RO associated with a first PRACH configuration with a lowest index value overlaps with a second RO associated with a second PRACH configuration with a higher index value, the frequency offset may be applied to the second RO in connection with the second PRACH configuration having a higher index value than the first PRACH configuration. Further, if the first and second ROs also overlap with a third RO associated with a third PRACH configuration having a higher index value than the second PRACH configuration, the frequency offset may be applied again to the third RO (e.g., from the frequency resulting from applying the frequency offset to the second RO) in connection with the third PRACH configuration having a higher index value than the second PRACH configuration. In some aspects, the UE 120 may assume that the frequency offset is to be added in a case in which multiple ROs associated with different PRACH configurations overlap. That is, the UE 120, in connection with determining that ROs associated with different PRACH configurations overlap, may apply the frequency offset in accordance with the index values of the PRACH configurations associated with the overlapping ROs.

In some aspects, in a case in which multiple ROs associated with different PRACH configurations overlap, the UE 120 may drop one or more of the overlapping ROs (e.g., the UE 120 may drop all but one of the overlapping ROs). “Dropping” an RO may refer to the UE 120 refraining from including the RO among the ROs (e.g., the valid ROs) that can be used by the UE 120 for transmitting a PRACH transmission. Accordingly, when the UE 120 drops an RO, the RO cannot be selected by the UE 120 for transmitting a PRACH transmission. In some aspects, in a case in which a first RO associated with a first PRACH configuration overlaps with a second RO associated with a second RACH configuration, the UE 120 may drop the first RO or the second RO based at least in part on a value of a first index (x) associated with the first PRACH configuration and a value of a second index (y) associated with the second PRACH configuration. In some examples, the UE 120 may drop the RO associated with the PRACH configuration having the higher index value. For example, in a case in which x<y, the UE 120 may drop the second RO. In some other examples, the UE 120 may drop the RO associated with the PRACH configuration having the lower index value. For example, in a case in which x<y, the UE 120 may drop the first RO. In some aspects, the UE 120 may drop one or more ROs in connection with multiple ROs associated with different PRACH configurations overlapping in the time domain and the frequency domain. In some examples, the UE 120 may refrain from dropping an RO, of two ROs that overlap in the time domain, in connection with the two ROs mapped to non-overlapping frequency resources (e.g., the two ROs being frequency division multiplexed).

In some aspects, there may be no overlap between ROs associated with different PRACH configurations of the plurality of PRACH configurations. In such examples, ROs associated with a first PRACH configuration may not overlap with ROs associated with a second PRACH configuration. For example, there may be no overlap in the time domain between any RO associated with the first PRACH configuration and any RO associated with the second PRACH configuration. In some examples, the network node 110 may determine the configuration information for the plurality of PRACH configurations (e.g., SSB-to-RO mapping parameters for the plurality of PRACH configurations) such that the ROs associated with the different PRACH configurations do not overlap. For example, the network node 110 may be required (e.g., in accordance with a wireless communication standard) to configure the PRACH configurations such that the ROs associated with the different PRACH configurations do not overlap. In such examples, the UE 120 may not expect to receive configuration information that configures overlapping ROs associated with different PRACH configurations. For example, the UE 120 may consider a case in which multiple ROs associated with different PRACH configurations overlap to be an error case (e.g., the UE 120 may detect an error case in connection with determining that ROs associated with different PRACH configurations overlap). In some aspects, the configuration information may be permitted to configure ROs associated with different PRACH configurations that overlap in the time domain, as long as the ROs are mapped to non-overlapping frequency resources (e.g., the ROs are frequency division multiplexed). In such examples, the UE 120 may detect an error case in connection with determining that ROs associated with different PRACH configurations overlap in the time domain and the frequency domain.

As further shown in FIG. 5A, and by reference number 515, in some aspects, the network node 110 may transmit, and the UE 120 may receive, an indication to enable/disable one or more PRACH configurations of the plurality of PRACH configurations and/or to update one or more PRACH configurations of the plurality of PRACH configurations.

In some aspects, the network node 110 may transmit, and the UE 120 may receive, an indication of one or more enabled PRACH configurations (and/or one or more disabled PRACH configurations). In some examples, the indication may indicate which of the plurality of PRACH configurations are enabled (and/or which of the plurality PRACH configurations are disabled). In such examples, the network node 110 may signal an update in the time domain (e.g., adaptation of the PRACH resources in the time domain) by indicating an enabled or disabled indication for each PRACH configuration, of the plurality of PRACH configurations. For example, the indication transmitted by the network node 110, and received by the UE 120, may include a bitmap that indicates whether each PRACH configuration, of the plurality of PRACH configurations, is enabled or disabled. The bitmap may include a number of bits corresponding to the number of PRACH configurations. Each bit may have a first value (e.g., 1) that indicates that a respective PRACH configuration, of the plurality of PRACH configurations, is enabled, or a second value (e.g., 0) that indicates that the respective PRACH configuration, of the plurality of PRACH configurations, is disabled. In some aspects, the indication of the enabled/disabled PRACH configurations may be included in a paging message transmitted by the network node 110. For example, the indication of the enabled/disabled PRACH configurations may be included in paging early indication DCI transmitted by the network node 110. In some aspects, the configuration information may indicate one or more initial PRACH configurations (for example, one or more default or baseline PRACH configurations) that are enabled, and the network node 110 may transmit the indication of the enabled/disabled PRACH configurations in the paging message (e.g., in early paging indication DCI) to update or change a selection of which PRACH configurations are enabled and/or disabled. In this way, the network (e.g., the network node 110) can selectively adapt the ROs available for PRACH transmission in certain beam directions (e.g., associated with certain SSBs) at different times.

FIG. 5C shows an example of indicating different enabled/disabled PRACH configurations at different times. As shown in FIG. 5C, and by reference number 560, the configuration information may indicate a first PRACH configuration that indicates a first subset of SSBs, from a set of four SSBs (e.g., SSB0, SSB1, SSB2, and SSB3), that are mapped to ROs associated with the first PRACH configuration, a second PRACH configuration that indicates a second subset of SSBs, from the set of four SSBs, that are mapped to ROs associated with the second PRACH configuration, and a third PRACH configuration that indicates a third subset of SSBs, from the set of four SSBs, that are mapped to ROs associated with the third PRACH configuration. The first PRACH configuration (shown as “Config 1”) may indicate a bitmap (e.g., in an SSB-PositionInBurst IE) of 1111 to indicate that the first subset of SSBs (shown using solid lines in FIG. 5C) includes SSB0, SSB1, SSB2, and SSB3. The second PRACH configuration (shown as “Config 2”) may indicate a bitmap (e.g., in an SSB-PositionInBurst IE) of 1010 to indicate that the second subset of SSBs (shown using dashed lines in FIG. 5C) includes SSB0 and SSB2. The third PRACH configuration (shown as “Config 3”) may indicate a bitmap (e.g., in an SSB-PositionInBurst IE) of 1100 to indicate that the third subset of SSBs (shown using dotted lines in FIG. 5C) includes SSB0 and SSB1.

As shown by reference number 565, the network node 110 may transmit, and the UE 120 may receive, a first indication of enabled/disabled PRACH configurations at a first time. For example, the first indication of enabled/disabled PRACH configurations may include a bitmap of 100 that indicates that the first PRACH configuration is enabled, the second PRACH configuration is disabled, and the third PRACH configuration is disabled. As shown by reference number 570, in connection with the first indication of enabled/disabled PRACH configurations, the second PRACH configuration and the third PRACH configuration may be disabled, while the first PRACH configuration may remain enabled. For example, the UE 120 may only use ROs associated with the first PRACH configuration (e.g., the enabled PRACH configuration) for transmitting a PRACH transmission.

As shown by reference number 575, the network node 110 may transmit, and the UE 120 may receive, a second indication of enabled/disabled PRACH configurations at a second time. For example, the second indication of enabled/disabled PRACH configurations may include a bitmap of 110 that indicates that the first PRACH configuration is enabled, the second PRACH configuration is enabled, and the third PRACH configuration is disabled. As shown by reference number 580, in connection with the second indication of enabled/disabled PRACH configurations, the first PRACH configuration may remain enabled, the second PRACH configuration may become enabled, and the third PRACH configuration may remain disabled. For example, the UE 120 may use ROs associated with the first and second PRACH configurations (e.g., the enabled PRACH configurations) for transmitting a PRACH transmission.

Returning to FIG. 5A, in some aspects, the network node 110 may transmit, and the UE 120 may receive, an indication of a change (or update) to the respective subset of SSBs indicated in at least one PRACH configuration of the plurality of PRACH configurations. For example, the indication of a change to the respective subset of SSBs indicated in a PRACH configuration may include an updated bitmap that indicates a change to the bitmap indicated (e.g., in the SSB-PositionInBurst IE) in the PRACH configuration. In such examples, the updated bitmap may indicate which SSBs, of the set of SSBs, are included in an updated subset of SSBs that are mapped to the ROs associated with the PRACH configuration. In this way, the network (e.g., the network node 110) can selectively adapt the ROs available for PRACH transmission in certain beam directions (e.g., associated with certain SSBs) at different times. For example, the network node 110 may transmit one or more indications of changes to the respective subsets of SSBs indicated in one or more PRACH configurations in addition to or instead of indicating the enabled/disabled PRACH configurations.

As further shown in FIG. 5A, and by reference number 520, the UE 120 may transmit, and the network node 110 may receive, a PRACH transmission in an RO associated with a PRACH configuration, of the plurality of PRACH configurations, in accordance with the configuration information. In some aspects, the PRACH transmission may be a RAM, such as msg1 of a four-step random access procedure or msgA of a two-step random access procedure. In some aspects, the PRACH transmission may be associated with contention-based random access. In some aspects, the PRACH transmission may be associated with contention-based random access (CBRA) or contention-free random access (CFRA).

As discussed above in connection with reference number 505, the UE 120 may measure a signal strength of one or more detected SSBs (e.g., in an SSB burst), and the UE 120 may select an SSB based at least in part on the signal strength measurements of the one or more detected SSBs. For example, the UE 120 may select a strongest SSB (e.g., an SSB with the strongest signal strength) of the one or more detected SSBs. In some aspects, when the UE 120 performs a RACH operation (e.g., when the UE 120 transmits the PRACH transmission), the UE 120 may select an RO associated with a PRACH configuration of the plurality of PRACH configurations. For example, the UE 120 may select an RO, from a set of ROs associated with the plurality of RACH configurations, that is associated with a detected SSB (e.g., the selected SSB), and the UE 120 may transmit the PRACH transmission in the selected RO. In some examples, in a case in which one or more PRACH configurations, of the plurality of PRACH configurations, are enabled and one or more PRACH configurations, of the plurality of PRACH configurations, are disabled, the UE 120 may select an RO, from a set of ROs associated with the one or more enabled PRACH configurations, that is associated with the selected SSB, and the UE 120 may transmit the PRACH transmission in the selected RO.

In some cases, a detected SSB (e.g., the selected SSB) may be mapped to ROs associated with multiple PRACH configurations of the plurality of PRACH configurations. In some aspects, the UE 120 may select a next available RO that is associated with the selected SSB from the set of ROs associated with the plurality of PRACH configurations (or from the set of ROs associated with the one or more enabled PRACH configurations). That is, the UE 120 may transmit the PRACH transmission using the PRACH configuration associated with the first available RO to which the selected SSB is mapped. In this way, latency of the PRACH transmission and the random access procedure may be reduced. In some aspects, in a case in which the selected SSB is mapped to ROs associated with multiple PRACH configurations, the UE 120 may select an RO associated with a PRACH configuration, of the multiple PRACH configurations, with a largest number of SSBs in the respective subset of SSBs. That is, the UE 120 may select an RO associated with a PRACH configuration, of the multiple PRACH configurations, that serves the most beam directions. In this way, collisions of PRACH transmissions (e.g., from different UEs) in the same RO may be reduced. In some aspects, in a case in which the selected SSB is mapped to ROs associated with multiple PRACH configurations, the UE 120 may select an RO associated with a PRACH configuration, of the multiple PRACH configurations, with a smallest number of SSBs in the respective subset of SSBs. That is, the UE 120 may select an RO associated with a PRACH configuration, of the multiple PRACH configurations, that serves the fewest beam directions. In this way, CLI associated with PRACH transmissions may be reduced. In some aspects, the network node 110 may indicate (e.g., in the configuration information) whether the UE 120 is to select the RO associated with the PRACH configuration that serves the most beam directions or the fewest beam directions.

As further shown in FIG. 5A, and by reference number 525, the UE 120 and the network node 110 may establish an RRC connection based at least in part on the PRACH transmission. For example, the PRACH transmission may initiate a random access procedure, and the network node 110 and the UE 120 may communicate to establish an RRC connection in accordance with the random access procedure. In some examples, the PRACH transmission may be a msg1 in the four-step random access procedure described above in connection with FIG. 4. In this case, the network node 110 and the UE 120 may communicate to perform the remaining steps of the four-step random access procedure, as described above in connection with FIG. 4. In some other examples, the PRACH transmission may be a msgA of a two-step random access procedure. In this case, the network node 110 and the UE 120 may communicate to perform the remaining steps of the two-step random access procedure to establish the RRC connection.

As indicated above, FIGS. 5A-5C are provided as an example. Other examples may differ from what is described with respect to FIGS. 5A-5C.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with PRACH configurations for spatial domain adaptation.

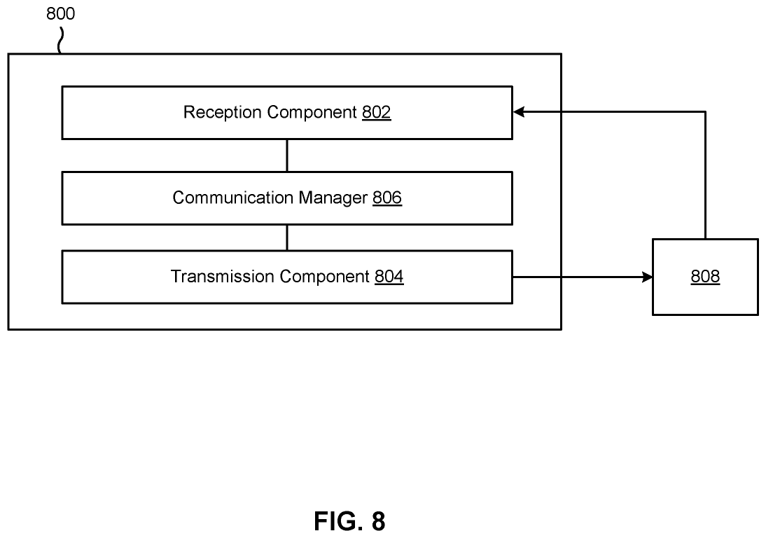

As shown in FIG. 6, in some aspects, process 600 may include receiving configuration information indicating a plurality of PRACH configurations, wherein each PRACH configuration, of the plurality of PRACH configurations, indicates a respective subset of SSBs, from a set of SSBs, that are mapped to ROs associated with that PRACH configuration (block 610). For example, the UE (e.g., using reception component 802 and/or communication manager 806, depicted in FIG. 8) may receive configuration information indicating a plurality of PRACH configurations, wherein each PRACH configuration, of the plurality of PRACH configurations, indicates a respective subset of SSBs, from a set of SSBs, that are mapped to ROs associated with that PRACH configuration, as described above.

As further shown in FIG. 6, in some aspects, process 600 may include transmitting a PRACH transmission in an RO associated with a PRACH configuration of the plurality of PRACH configurations in accordance with the configuration information (block 620). For example, the UE (e.g., using transmission component 804 and/or communication manager 806, depicted in FIG. 8) may transmit a PRACH transmission in an RO associated with a PRACH configuration of the plurality of PRACH configurations in accordance with the configuration information, as described above.

Process 600 may include additional aspects, such as any single aspect or any combination of aspects described below and/or in connection with one or more other processes described elsewhere herein.

In a first aspect, each PRACH configuration, of the plurality of PRACH configurations, includes a respective bitmap that indicates which SSBs, of the set of SSBs, are included in the respective subset of SSBs.

In a second aspect, alone or in combination with the first aspect, for each PRACH configuration, the respective bitmap includes a plurality of bits, with each bit, of the plurality of bits, indicating whether a respective SSB, of the set of SSBs, is included in the respective subset of SSBs that are mapped to the ROs associated with that PRACH configuration.

In a third aspect, alone or in combination with one or more of the first and second aspects, each PRACH configuration, of the plurality of PRACH configurations, includes a respective IE for indicating the respective subset of SSBs.

In a fourth aspect, alone or in combination with one or more of the first through third aspects, the configuration information is included in a SIB1.

In a fifth aspect, alone or in combination with one or more of the first through fourth aspects, each PRACH configuration, of the plurality of PRACH configurations, indicates a respective SSB-to-RO mapping that maps the respective subset of SSBs to the ROs associated with that PRACH configuration.

In a sixth aspect, alone or in combination with one or more of the first through fifth aspects, the plurality of PRACH configurations includes a first PRACH configuration that indicates a first subset of SSBs, from the set of SSBs, that are mapped to ROs associated with the first PRACH configuration, and a second PRACH configuration that indicates a second subset of SSBs, from the set of SSBs, that are mapped to ROs associated with the second PRACH configuration.

In a seventh aspect, alone or in combination with one or more of the first through sixth aspects, the ROs associated with the first PRACH configuration do not overlap with the ROs associated with the second PRACH configuration.

In an eighth aspect, alone or in combination with one or more of the first through seventh aspects, a first RO, of the ROs associated with the first PRACH configuration, overlaps with a second RO, of the ROs associated with the second PRACH configuration, and a frequency offset is associated with the first RO or the second RO based at least in part on a value of a first index associated with the first PRACH configuration and a value of a second index associated with the second PRACH configuration.

In a ninth aspect, alone or in combination with one or more of the first through eighth aspects, a first RO, of the ROs associated with the first PRACH configuration, overlaps with a second RO, of the ROs associated with the second PRACH configuration, and the first RO or the second RO is dropped based at least in part on a value of a first index associated with the first PRACH configuration and a value of a second index associated with the second PRACH configuration.

In a tenth aspect, alone or in combination with one or more of the first through ninth aspects, transmitting the PRACH transmission includes transmitting the PRACH transmission in a selected RO, from a set of ROs associated with the plurality of PRACH configurations, that is associated with a detected SSB.

In an eleventh aspect, alone or in combination with one or more of the first through tenth aspects, the selected RO is a next available RO associated with the detected SSB from the set of ROs associated with the plurality of PRACH configurations.

In a twelfth aspect, alone or in combination with one or more of the first through eleventh aspects, the detected SSB is mapped to ROs associated with multiple PRACH configurations of the plurality of PRACH configurations, and the selected RO is an RO associated with a PRACH configuration, of the multiple PRACH configurations, with a largest number of SSBs in the respective subset of SSBs.

In a thirteenth aspect, alone or in combination with one or more of the first through twelfth aspects, the detected SSB is mapped to ROs associated with multiple PRACH configurations of the plurality of PRACH configurations, and the selected RO is an RO associated with a PRACH configuration, of the multiple PRACH configurations, with a smallest number of SSBs in the respective subset of SSBs.

In a fourteenth aspect, alone or in combination with one or more of the first through thirteenth aspects, process 600 includes receiving an indication of one or more enabled PRACH configurations of the plurality of PRACH configurations, wherein transmitting the PRACH transmission includes transmitting the PRACH transmission in a selected RO from a set of ROs associated with the one or more enabled PRACH configurations.

In a fifteenth aspect, alone or in combination with one or more of the first through fourteenth aspects, the indication of the one or more enabled PRACH configurations includes a bitmap that indicates whether each PRACH configuration, of the plurality of PRACH configurations, is enabled or disabled.

In a sixteenth aspect, alone or in combination with one or more of the first through fifteenth aspects, process 600 includes receiving an indication of a change to the respective subset of SSBs indicated in a PRACH configuration of the plurality of PRACH configurations.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with PRACH configurations for spatial domain adaptation.

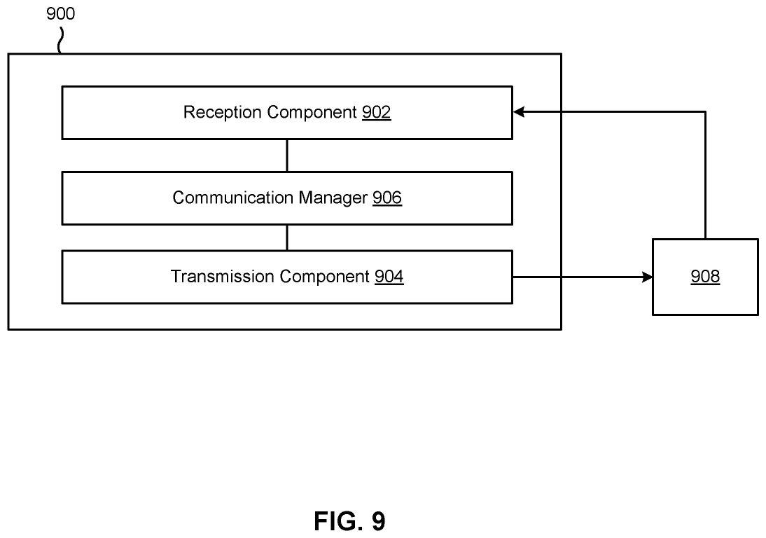

As shown in FIG. 7, in some aspects, process 700 may include transmitting configuration information indicating a plurality of PRACH configurations, wherein each PRACH configuration, of the plurality of PRACH configurations, indicates a respective subset of SSBs, from a set of SSBs, that are mapped to ROs associated with that PRACH configuration (block 710). For example, the network node (e.g., using transmission component 904 and/or communication manager 906, depicted in FIG. 9) may transmit configuration information indicating a plurality of PRACH configurations, wherein each PRACH configuration, of the plurality of PRACH configurations, indicates a respective subset of SSBs, from a set of SSBs, that are mapped to ROs associated with that PRACH configuration, as described above.

As further shown in FIG. 7, in some aspects, process 700 may include receiving, from a UE, a PRACH transmission in an RO associated with a PRACH configuration of the plurality of PRACH configurations in accordance with the configuration information (block 720). For example, the network node (e.g., using reception component 902 and/or communication manager 906, depicted in FIG. 9) may receive, from a UE, a PRACH transmission in an RO associated with a PRACH configuration of the plurality of PRACH configurations in accordance with the configuration information, as described above.

Process 700 may include additional aspects, such as any single aspect or any combination of aspects described below and/or in connection with one or more other processes described elsewhere herein.

In a first aspect, each PRACH configuration, of the plurality of PRACH configurations, includes a respective bitmap that indicates which SSBs, of the set of SSBs, are included in the respective subset of SSBs.

In a second aspect, alone or in combination with the first aspect, for each PRACH configuration, the respective bitmap includes a plurality of bits, with each bit, of the plurality of bits, indicating whether a respective SSB, of the set of SSBs, is included in the respective subset of SSBs that are mapped to the ROs associated with that PRACH configuration.

In a third aspect, alone or in combination with one or more of the first and second aspects, each PRACH configuration, of the plurality of PRACH configurations, includes a respective IE for indicating the respective subset of SSBs.

In a fourth aspect, alone or in combination with one or more of the first through third aspects, the configuration information is included in a SIB1.

In a fifth aspect, alone or in combination with one or more of the first through fourth aspects, each PRACH configuration, of the plurality of PRACH configurations, indicates a respective SSB-to-RO mapping that maps the respective subset of SSBs to the ROs associated with that PRACH configuration.

In a sixth aspect, alone or in combination with one or more of the first through fifth aspects, the plurality of PRACH configurations includes a first PRACH configuration that indicates a first subset of SSBs, from the set of SSBs, that are mapped to ROs associated with the first PRACH configuration, and a second PRACH configuration that indicates a second subset of SSBs, from the set of SSBs, that are mapped to ROs associated with the second PRACH configuration.

In a seventh aspect, alone or in combination with one or more of the first through sixth aspects, the ROs associated with the first PRACH configuration do not overlap with the ROs associated with the second PRACH configuration.

In an eighth aspect, alone or in combination with one or more of the first through seventh aspects, a first RO, of the ROs associated with the first PRACH configuration, overlaps with a second RO, of the ROs associated with the second PRACH configuration, and a frequency offset is associated with the first RO or the second RO based at least in part on a value of a first index associated with the first PRACH configuration and a value of a second index associated with the second PRACH configuration.

In a ninth aspect, alone or in combination with one or more of the first through eighth aspects, a first RO, of the ROs associated with the first PRACH configuration, overlaps with a second RO, of the ROs associated with the second PRACH configuration, and the first RO or the second RO is dropped based at least in part on a value of a first index associated with the first PRACH configuration and a value of a second index associated with the second PRACH configuration.

In a tenth aspect, alone or in combination with one or more of the first through ninth aspects, process 700 includes transmitting an indication of one or more enabled PRACH configurations of the plurality of PRACH configurations, wherein receiving the PRACH transmission includes receiving the PRACH transmission in an RO from a set of ROs associated with the one or more enabled PRACH configurations.

In an eleventh aspect, alone or in combination with one or more of the first through tenth aspects, the indication of the one or more enabled PRACH configurations includes a bitmap that indicates whether each PRACH configuration, of the plurality of PRACH configurations, is enabled or disabled.

In a twelfth aspect, alone or in combination with one or more of the first through eleventh aspects, process 700 includes transmitting an indication of a change to the respective subset of SSBs indicated in a PRACH configuration of the plurality of PRACH configurations.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4 and 5A-5C. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The transmission component 804 may transmit a PRACH transmission in an RO associated with a PRACH configuration of the plurality of PRACH configurations in accordance with the configuration information.

The reception component 802 may receive an indication of one or more enabled PRACH configurations of the plurality of PRACH configurations.

The reception component 802 may receive an indication of a change to the respective subset of SSBs indicated in a PRACH configuration of the plurality of PRACH configurations.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4 and 5A-5C. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit configuration information indicating a plurality of PRACH configurations, wherein each PRACH configuration, of the plurality of PRACH configurations, indicates a respective subset of SSBs, from a set of SSBs, that are mapped to ROs associated with that PRACH configuration. The reception component 902 may receive, from a UE, a PRACH transmission in an RO associated with a PRACH configuration of the plurality of PRACH configurations in accordance with the configuration information.

The transmission component 904 may transmit an indication of one or more enabled PRACH configurations of the plurality of PRACH configurations.

The transmission component 904 may transmit an indication of a change to the respective subset of SSBs indicated in a PRACH configuration of the plurality of PRACH configurations.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving configuration information indicating a plurality of physical random access channel (PRACH) configurations, wherein each PRACH configuration, of the plurality of PRACH configurations, indicates a respective subset of synchronization signal blocks (SSBs), from a set of SSBs, that are mapped to random access channel (RACH) occasions (ROs) associated with that PRACH configuration; and transmitting a PRACH transmission in an RO associated with a PRACH configuration of the plurality of PRACH configurations in accordance with the configuration information.

Aspect 2: The method of Aspect 1, wherein each PRACH configuration, of the plurality of PRACH configurations, includes a respective bitmap that indicates which SSBs, of the set of SSBs, are included in the respective subset of SSBs.

Aspect 3: The method of Aspect 2, wherein for each PRACH configuration, the respective bitmap includes a plurality of bits, with each bit, of the plurality of bits, indicating whether a respective SSB, of the set of SSBs, is included in the respective subset of SSBs that are mapped to the ROs associated with that PRACH configuration.

Aspect 4: The method of any of Aspects 1-3, wherein each PRACH configuration, of the plurality of PRACH configurations, includes a respective information element (IE) for indicating the respective subset of SSBs.

Aspect 5: The method of any of Aspects 1-4, wherein the configuration information is included in a system information block type 1 (SIB1).

Aspect 6: The method of any of Aspects 1-5, wherein each PRACH configuration, of the plurality of PRACH configurations, indicates a respective SSB-to-RO mapping that maps the respective subset of SSBs to the ROs associated with that PRACH configuration.

Aspect 7: The method of any of Aspects 1-6, wherein the plurality of PRACH configurations includes: a first PRACH configuration that indicates a first subset of SSBs, from the set of SSBs, that are mapped to ROs associated with the first PRACH configuration, and a second PRACH configuration that indicates a second subset of SSBs, from the set of SSBs, that are mapped to ROs associated with the second PRACH configuration.

Aspect 8: The method of Aspect 7, wherein the ROs associated with the first PRACH configuration do not overlap with the ROs associated with the second PRACH configuration.

Aspect 9: The method of Aspect 7, wherein a first RO, of the ROs associated with the first PRACH configuration, overlaps with a second RO, of the ROs associated with the second PRACH configuration, and wherein a frequency offset is associated with the first RO or the second RO based at least in part on a value of a first index associated with the first PRACH configuration and a value of a second index associated with the second PRACH configuration.

Aspect 10: The method of Aspect 7, wherein a first RO, of the ROs associated with the first PRACH configuration, overlaps with a second RO, of the ROs associated with the second PRACH configuration, and wherein the first RO or the second RO is dropped based at least in part on a value of a first index associated with the first PRACH configuration and a value of a second index associated with the second PRACH configuration.

Aspect 11: The method of any of Aspects 1-10, wherein transmitting the PRACH transmission comprises: transmitting the PRACH transmission in a selected RO, from a set of ROs associated with the plurality of PRACH configurations, that is associated with a detected SSB.

Aspect 12: The method of Aspect 11, wherein the selected RO is a next available RO associated with the detected SSB from the set of ROs associated with the plurality of PRACH configurations.

Aspect 13: The method of Aspect 11, wherein the detected SSB is mapped to ROs associated with multiple PRACH configurations of the plurality of PRACH configurations, and wherein the selected RO is an RO associated with a PRACH configuration, of the multiple PRACH configurations, with a largest number of SSBs in the respective subset of SSBs.

Aspect 14: The method of Aspect 11, wherein the detected SSB is mapped to ROs associated with multiple PRACH configurations of the plurality of PRACH configurations, and wherein the selected RO is an RO associated with a PRACH configuration, of the multiple PRACH configurations, with a smallest number of SSBs in the respective subset of SSBs.

Aspect 15: The method of any of Aspects 1-14, further comprising receiving an indication of one or more enabled PRACH configurations of the plurality of PRACH configurations, wherein transmitting the PRACH transmission comprises: transmitting the PRACH transmission in a selected RO from a set of ROs associated with the one or more enabled PRACH configurations.

Aspect 16: The method of Aspect 15, wherein the indication of the one or more enabled PRACH configurations includes a bitmap that indicates whether each PRACH configuration, of the plurality of PRACH configurations, is enabled or disabled.

Aspect 17: The method of any of Aspects 1-16, further comprising: receiving an indication of a change to the respective subset of SSBs indicated in a PRACH configuration of the plurality of PRACH configurations.

Aspect 18: A method of wireless communication performed by a network node, comprising: transmitting configuration information indicating a plurality of physical random access channel (PRACH) configurations, wherein each PRACH configuration, of the plurality of PRACH configurations, indicates a respective subset of synchronization signal blocks (SSBs), from a set of SSBs, that are mapped to random access channel (RACH) occasions (ROs) associated with that PRACH configuration; and receiving, from a user equipment (UE), a PRACH transmission in an RO associated with a PRACH configuration of the plurality of PRACH configurations in accordance with the configuration information.

Aspect 19: The method of Aspect 18, wherein each PRACH configuration, of the plurality of PRACH configurations, includes a respective bitmap that indicates which SSBs, of the set of SSBs, are included in the respective subset of SSBs.

Aspect 20: The method of Aspect 19, wherein for each PRACH configuration, the respective bitmap includes a plurality of bits, with each bit, of the plurality of bits, indicating whether a respective SSB, of the set of SSBs, is included in the respective subset of SSBs that are mapped to the ROs associated with that PRACH configuration.

Aspect 21: The method of any of Aspects 18-20, wherein each PRACH configuration, of the plurality of PRACH configurations, includes a respective information element (IE) for indicating the respective subset of SSBs.

Aspect 22: The method of any of Aspects 18-21, wherein the configuration information is included in a system information block type 1 (SIB1).

Aspect 23: The method of any of Aspects 18-22, wherein each PRACH configuration, of the plurality of PRACH configurations, indicates a respective SSB-to-RO mapping that maps the respective subset of SSBs to the ROs associated with that PRACH configuration.

Aspect 24: The method of any of Aspects 18-23, wherein the plurality of PRACH configurations includes: a first PRACH configuration that indicates a first subset of SSBs, from the set of SSBs, that are mapped to ROs associated with the first PRACH configuration, and a second PRACH configuration that indicates a second subset of SSBs, from the set of SSBs, that are mapped to ROs associated with the second PRACH configuration.

Aspect 25: The method of Aspect 24, wherein the ROs associated with the first PRACH configuration do not overlap with the ROs associated with the second PRACH configuration.

Aspect 26: The method of Aspect 24, wherein a first RO, of the ROs associated with the first PRACH configuration, overlaps with a second RO, of the ROs associated with the second PRACH configuration, and wherein a frequency offset is associated with the first RO or the second RO based at least in part on a value of a first index associated with the first PRACH configuration and a value of a second index associated with the second PRACH configuration.

Aspect 27: The method of Aspect 24, wherein a first RO, of the ROs associated with the first PRACH configuration, overlaps with a second RO, of the ROs associated with the second PRACH configuration, and wherein the first RO or the second RO is dropped based at least in part on a value of a first index associated with the first PRACH configuration and a value of a second index associated with the second PRACH configuration.

Aspect 28: The method of any of Aspects 18-27, further comprising transmitting an indication of one or more enabled PRACH configurations of the plurality of PRACH configurations, wherein receiving the PRACH transmission comprises: receiving the PRACH transmission in an RO from a set of ROs associated with the one or more enabled PRACH configurations.

Aspect 29: The method of Aspect 28, wherein the indication of the one or more enabled PRACH configurations includes a bitmap that indicates whether each PRACH configuration, of the plurality of PRACH configurations, is enabled or disabled.

Aspect 30: The method of any of Aspects 18-29, further comprising: transmitting an indication of a change to the respective subset of SSBs indicated in a PRACH configuration of the plurality of PRACH configurations.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors coupled to the one or more memories, the one or more processors individually or collectively configured to:
receive configuration information indicating a plurality of physical random access channel (PRACH) configurations, wherein each PRACH configuration, of the plurality of PRACH configurations, indicates a respective subset of synchronization signal blocks (SSBs), from a set of SSBs, that are mapped to random access channel (RACH) occasions (ROs) associated with that PRACH configuration; and
transmit a PRACH transmission in an RO associated with a PRACH configuration of the plurality of PRACH configurations in accordance with the configuration information.

2. The UE of claim 1, wherein each PRACH configuration, of the plurality of PRACH configurations, includes a respective bitmap that indicates which SSBs, of the set of SSBs, are included in the respective subset of SSBs.

3. The UE of claim 2, wherein for each PRACH configuration, the respective bitmap includes a plurality of bits, with each bit, of the plurality of bits, indicating whether a respective SSB, of the set of SSBs, is included in the respective subset of SSBs that are mapped to the ROs associated with that PRACH configuration.

4. The UE of claim 1, wherein each PRACH configuration, of the plurality of PRACH configurations, includes a respective information element (IE) for indicating the respective subset of SSBs.

5. The UE of claim 1, wherein the configuration information is included in a system information block type 1 (SIB1).

6. The UE of claim 1, wherein each PRACH configuration, of the plurality of PRACH configurations, indicates a respective SSB-to-RO mapping that maps the respective subset of SSBs to the ROs associated with that PRACH configuration.

7. The UE of claim 1, wherein the plurality of PRACH configurations includes:
a first PRACH configuration that indicates a first subset of SSBs, from the set of SSBs, that are mapped to ROs associated with the first PRACH configuration, and
a second PRACH configuration that indicates a second subset of SSBs, from the set of SSBs, that are mapped to ROs associated with the second PRACH configuration.

8. The UE of claim 7, wherein the ROs associated with the first PRACH configuration do not overlap with the ROs associated with the second PRACH configuration.

9. The UE of claim 7, wherein a first RO, of the ROs associated with the first PRACH configuration, overlaps with a second RO, of the ROs associated with the second PRACH configuration, and
wherein a frequency offset is associated with the first RO or the second RO based at least in part on a value of a first index associated with the first PRACH configuration and a value of a second index associated with the second PRACH configuration.

10. The UE of claim 7, wherein a first RO, of the ROs associated with the first PRACH configuration, overlaps with a second RO, of the ROs associated with the second PRACH configuration, and
wherein the first RO or the second RO is dropped based at least in part on a value of a first index associated with the first PRACH configuration and a value of a second index associated with the second PRACH configuration.

11. The UE of claim 1, wherein the one or more processors, to transmit the PRACH transmission, are individually or collectively configured to:
transmit the PRACH transmission in a selected RO, from a set of ROs associated with the plurality of PRACH configurations, that is associated with a detected SSB.

12. The UE of claim 11, wherein the selected RO is a next available RO associated with the detected SSB from the set of ROs associated with the plurality of PRACH configurations.

13. The UE of claim 11, wherein the detected SSB is mapped to ROs associated with multiple PRACH configurations of the plurality of PRACH configurations, and wherein the selected RO is an RO associated with a PRACH configuration, of the multiple PRACH configurations, with a largest number of SSBs in the respective subset of SSBs.

14. The UE of claim 11, wherein the detected SSB is mapped to ROs associated with multiple PRACH configurations of the plurality of PRACH configurations, and wherein the selected RO is an RO associated with a PRACH configuration, of the multiple PRACH configurations, with a smallest number of SSBs in the respective subset of SSBs.

15. The UE of claim 1, wherein the one or more processors are further configured to cause the UE to receive an indication of one or more enabled PRACH configurations of the plurality of PRACH configurations, wherein the one or more processors, to transmit the PRACH transmission, are individually or collectively configured to:
transmit the PRACH transmission in a selected RO from a set of ROs associated with the one or more enabled PRACH configurations.

16. The UE of claim 15, wherein the indication of the one or more enabled PRACH configurations includes a bitmap that indicates whether each PRACH configuration, of the plurality of PRACH configurations, is enabled or disabled.

17. The UE of claim 1, wherein the one or more processors are further individually or collectively configured to cause the UE to:
receive an indication of a change to the respective subset of SSBs indicated in a PRACH configuration of the plurality of PRACH configurations.

18. A network node for wireless communication, comprising:
one or more memories; and
one or more processors coupled to the one or more memories, the one or more processors individually or collectively configured to:
transmit configuration information indicating a plurality of physical random access channel (PRACH) configurations, wherein each PRACH configuration, of the plurality of PRACH configurations, indicates a respective subset of synchronization signal blocks (SSBs), from a set of SSBs, that are mapped to random access channel (RACH) occasions (ROs) associated with that PRACH configuration; and
receive, from a user equipment (UE), a PRACH transmission in an RO associated with a PRACH configuration of the plurality of PRACH configurations in accordance with the configuration information.

19. The network node of claim 18, wherein each PRACH configuration, of the plurality of PRACH configurations, includes a respective bitmap that indicates which SSBs, of the set of SSBs, are included in the respective subset of SSBs.

20. A method of wireless communication performed by a user equipment (UE), comprising:
receiving configuration information indicating a plurality of physical random access channel (PRACH) configurations, wherein each PRACH configuration, of the plurality of PRACH configurations, indicates a respective subset of synchronization signal blocks (SSBs), from a set of SSBs, that are mapped to random access channel (RACH) occasions (ROs) associated with that PRACH configuration; and
transmitting a PRACH transmission in an RO associated with a PRACH configuration of the plurality of PRACH configurations in accordance with the configuration information.
